(19) United States
(12) Patent Application Publication
(10) Pub. No.: US 2005/0164766 A1
(43) Pub. Date: Jul. 28, 2005

(54) Pre-generated game creation methods and apparatus

(75) Inventors: Shai Haim, Tel-Aviv (IL); Arie Faingold, Petah Tikva (IL); Yael Regev, Tal Schachar (IL); Yevgeny Granat, Hod HaSharon (IL)

Correspondence Address: Schwegman, Lundberg, Woessner & Kluth, P.A., P.O. Box 2938, Minneapolis, MN, 55402, US

(73) Assignee: BettingCorp UK Ltd.

(21) Appl. No.: 11/044,696

(22) Filed: Jan. 27, 2005

Related U.S. Application Data
(60) Provisional application No. 60/540,043, filed on Jan. 27, 2004.

(51) Int. Cl. G06F 17/00; G06F 19/00

(52) U.S. Cl. 463/16; 463/26; 463/42

(57) ABSTRACT

In an embodiment, a method includes providing a user interface to receive a game type definition, which defines a pre-generated game type. The method further includes providing a user interface to receive pool-related parameters, which define a pool of pre-generated games containers for the pre-generated game.

### RELATED APPLICATION INFORMATION

The present application claims the benefit of the filing date of U.S. provisional application Ser. No. 60/540,043, filed Jan. 27, 2004, the contents of which is incorporated herein by reference.

### BACKGROUND

Some types of games may be implemented using pre-generated results. For example, a scratch card game may be implemented by pre-defining the game's criteria (e.g., rules, payout percentage, and spread), determining scratch card values that are consistent with the criteria, and printing a collection of scratch cards with those values. The cards may then be distributed to sales outlets, and sold to purchasers.

Creating a game's criteria, determining card values, and producing a collection of cards have traditionally been time and labor intensive processes, which are performed by skilled experts (e.g., statisticians and computer programmers). Further, some games may be implemented using thousands or millions of game pieces, which take significant amounts of time to produce and distribute.

### SUMMARY

In various embodiments, the inventive subject matter relates to methods and apparatus for processing information.

### BRIEF DESCRIPTION OF THE DRAWINGS

The appended claims point out different embodiments of the inventive subject matter with particularity. However, the detailed description presents a more complete understanding of the inventive subject matter when considered in connection with the figures, wherein like-reference numbers refer to similar items throughout the figures and:

FIG. 1 is a schematic block diagram of a computer system, in accordance with an example embodiment;

FIG. 2 illustrates an example of a representation of a veiled scratch card, in accordance with an example embodiment;

FIG. 3 illustrates an example of a representation of an unveiled scratch card, in accordance with an example embodiment;

FIG. 4 illustrates a depiction of a game development application, in accordance with an example embodiment;

FIG. 5 illustrates a flowchart of a method for creating and playing a pre-generated game, in accordance with an example embodiment;

FIG. 6 illustrates a flowchart of a method for creating a pool, in accordance with an example embodiment;

FIG. 7 illustrates an example of a game type definition window, in accordance with an example embodiment;

FIG. 8 illustrates an example of a game type definition window with an example game represented using lines of code, in accordance with an example embodiment;

FIG. 9 illustrates an example of a pool setup and configuration window, in accordance with an example embodiment;

FIG. 10 illustrates an example of a pool spread definition window, in accordance with an example embodiment;

FIG. 11 illustrates an example of a pool monitoring window, in accordance with an example embodiment; and

FIG. 12 illustrates a diagrammatic representation of machine in the example form of a computer system, within which a set of instructions, for causing the machine to perform any one or more of the methodologies discussed herein, may be executed.

### DETAILED DESCRIPTION

Embodiments include methods and apparatus for creating and playing games having pre-generated results, referred to herein as “pre-generated games.” Examples of applicable pre-generated games include, but are not limited to, scratch card games, keno, bingo, and other games that are played using pre-generated results. Although the description, below, describes implementing embodiments in a network-based scratch card game, it is to be understood that the scope of the subject matter includes other types of games having pre-determined results, as well.

Embodiments include methods and apparatus, which enable a game operator to design a game and to initiate creation of one or more “pools” of pre-generated “games containers” associated with a pre-generated game. As used herein, the term “games container” includes an electronic representation of one or more associated games (e.g., one or more games on a single scratch card). In an embodiment, the operator may design a game using a “game development application,” which includes a software application that may be executed on a computer. Using the game development application, the game operator may define a game type and specify pool-related information (e.g., pool setup and configuration information). The operator further may cause the game development application to create a pool of pre-generated games containers, among other things. Although the term “game operator” is used herein in a singular form, it is to be understood that more than one person may be involved in the process of specifying game-related and pool-related information, and causing the game development application to create a pool. Accordingly, the term “game operator” is meant to include a single person or multiple people.

A pre-generated games container may include, for example, an electronic representation of a scratch card or other game piece. A pool of pre-generated games containers may be stored on one or more database computers, in an embodiment, which are accessible to one or more server computers. When a pool is “opened,” some or all of the pre-generated games containers within the pool may be available to “game players” (e.g., people).

In an embodiment, a game player, through interaction with a client device, may request one or more pre-generated games containers from a server. A games container may be purchased for a sum of money, obtained in exchange for credits, or may be available for free. The server may then retrieve, decode, and send the one or more games containers to the client device. Game play may then be simulated at the client device (e.g., by the client device displaying a representation of the games container, and enabling the user to cause the client device to simulate scratching“various scratch boxes).

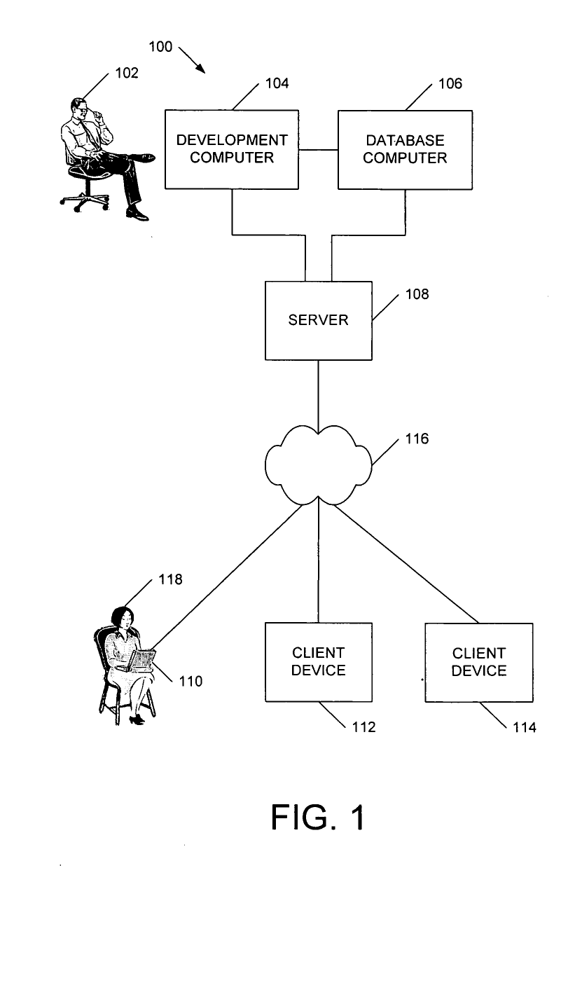

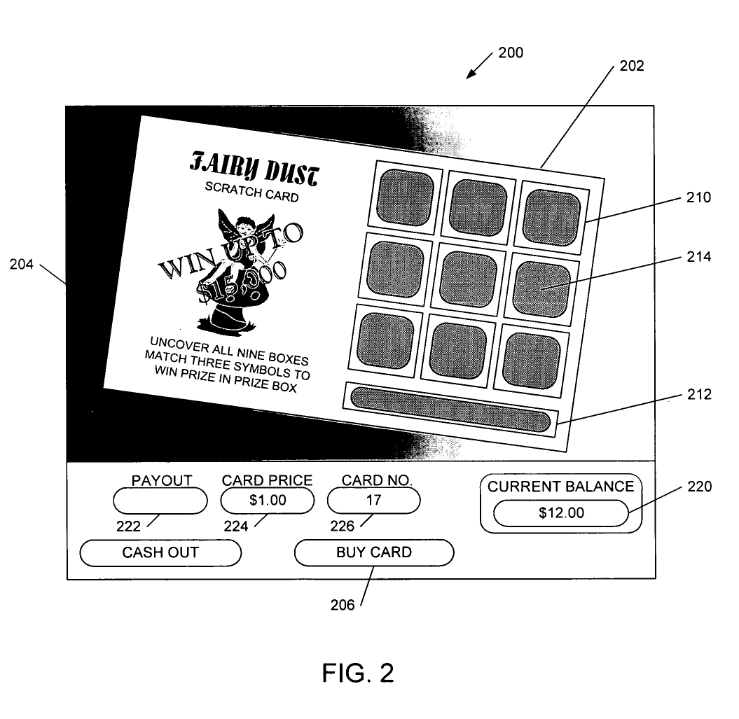

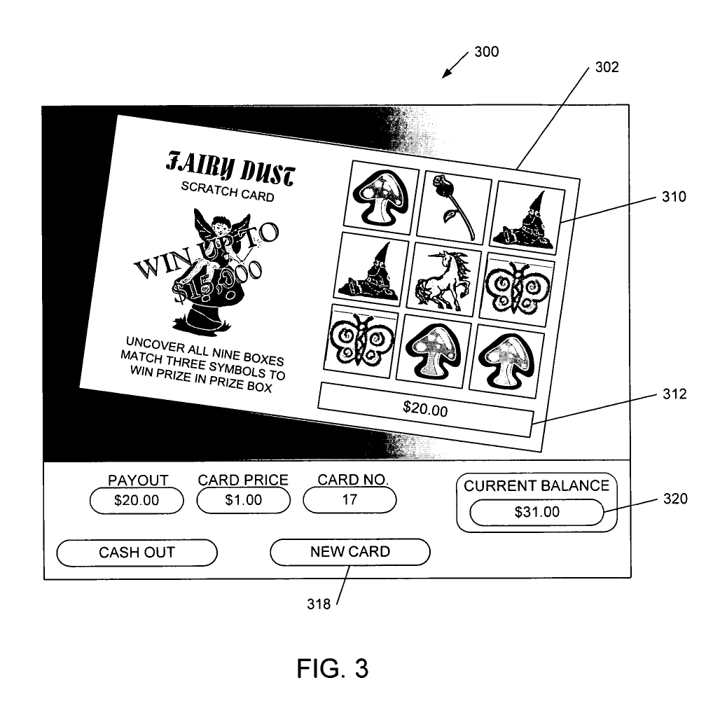

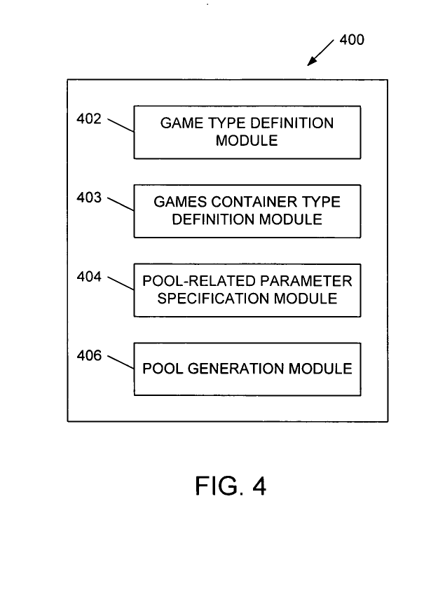

Embodiments of the inventive subject matter will now be described in more detail. In particular, an example system, in which various embodiments may be implemented, are described below in conjunction with FIG. 1. Examples of two display screens for a scratch card games container are then described in conjunction with FIGS. 2 and 3, in accordance with various embodiments. Methods and apparatus for specifying game-related and pool-related parameters, creating a pool, and playing a pre-generated game are then described in conjunction with FIGS. 4-12.

FIG. 1 is a schematic block diagram of a computer system 100, in accordance with an example embodiment. System 100 may include one or more development computers 104, database computers 106, servers 108, and clients 110, 112, 114. Although only one development computer 104, database computer 106, and server 108 are illustrated for purposes of simplicity, more of any of these computers 104, 106, 108 may be included within the system 100 to produce the desired functionality. Further, although three clients 110, 112, 114 are illustrated in FIG. 1, different numbers of clients 110, 112, 114 may be associated with system 100, and the numbers may change dynamically.

As used herein, the term “server” is intended to include one or more first computing devices or computer programs executing on one or more computing devices, which provide one or more services to client programs or client devices. The term “client,” as used herein, is intended to include a second computing device or computer program executing on a computing device, which may request services from a server. Use of the terms “server” and “client” are not meant to limit the scope of the subject matter to any particular type of system. Instead, these terms are used for convenience to indicate various elements of a network-based communication system.

In system 100, a game operator 102 may interact with a game development application, executed on development computer 104, to specify one or more types of games and pool-related parameters, and to initiate creation a pool of pre-generated games containers. The game development application may reside on development computer 104, or may reside on a remote computer (not illustrated). A game development application may provide a graphical user interface (e.g., one or more interactive windows), which enables the game operator 102 to define the game logic and rules for a particular type of game, in an embodiment. A game development application enables the game operator 102 to define the game logic and rules by creating a graphical representation of a game type, in an embodiment. A game development application may also enable the operator to associate game types together to define a “games container type,” which may include one or multiple identified game types, in an embodiment.

Further, in an embodiment, the game development application may automatically generate software (e.g., code) for a game type, based on the graphical representation. In another embodiment, the game development application may enable the game operator 102 to draft some or all game type definition software directly. In an embodiment, software for a game type may have a format that is consistent with a proprietary, “Instant Game Markup Language” (IGML), which will be described in more detail later. In another embodiment, software for a game type may have a format that is consistent with another proprietary or non-proprietary language (e.g., C++).

In an embodiment, a game development application may also enable the game operator 102 to specify various pool-related parameters. Once those parameters are specified, the game development application may be invoked to produce a pool of pre-generated games containers. In an embodiment, the pool may be downloaded to and stored on one or more database computers 106, which are accessible to one or more servers 108. Download may be achieved through a network or directly. Although development computer 104, database computer 106, and server 108 are illustrated as separate computing elements of system 100, computers 104, 106, 108 may be combined, in other embodiments.

Server 108 may communicate with one or more client devices 110, 112, 114 over one or more networks 116. In an embodiment, network 116 includes the Internet. In other embodiments, network 116 may include a local area network (LAN), a wide area network (WAN), a wireless LAN (WLAN), a radio area network (RAN), a personal area network (PAN) (e.g., a Bluetooth network), a cellular network, a satellite network, a public switched telephone network (PSTN), or any combination thereof. Although the description, below, describes implementing embodiments in a system that includes the Internet, it is to be understood that the scope of the subject matter includes systems that employ other types of networks to provide communications between a server and client, as well.

To play a game, a game player 118 (e.g., a user) may interact with a client device 110 to request one or more games containers from a pre-generated game application or other program executed by server 108. In a particular embodiment, player 118 may invoke a browser on the client device to access a website that manages the game. For example, a browser may access a website such as “www.playmontecarlo.com” (developed by BettingCorp UK Ltd., London, United Kingdom), and the player may indicate that he or she would like to play a “Scratch Card” game.

A pre-generated game application may include, for example but not by way of limitation, a Java-based, enterprise application, or an application programmed using a different language. A pre-generated game application, in accordance with various embodiments, may use proprietary standards (e.g., IGML) or open standards (e.g., HTML (Hyper-Text Markup Language), SGML (Standard Generalized Markup Language), XML (Extensible Markup Language), or others) and transport protocols (e.g., Hyper-Text Transfer Protocol (HTTP)) to exchange information and data with calling clients.

A client 110, 112, 114 may include one or more computing devices (e.g., processors) within a device such as a computer (e.g., a desktop or laptop computer), a personal data assistant (PDA), a two-way pager, a cellular telephone, a television set and set-top box, an interactive television (ITV) system, a video gaming terminal (VGT), a gaming system, a hotel service system, a consumer electronics device, a web appliance, devices combining these functionalities, or virtually any other electronic device capable of providing two-way network communications, displaying information pertaining to a pre-generated games container, and receiving user inputs associated with playing the game.

In response to a request from a client device 110, 112, 114, server 108 may retrieve the one or more games containers (e.g., from database computer 106 or elsewhere), decode the one or more games containers, and send the decoded games containers to client device 110, in an embodiment. The client device 110 may then display a representation of the games container (e.g., a scratch card), and enable the player 118 to interact with the representation to simulate game play.

In a scratch card embodiment, for example, a client device 110 may first display a representation of a “veiled” scratch card (e.g., a scratch card with coverings over the scratch card box images). A player may interact with the representation (e.g., through a user interface) to “scratch” off the coverings or “unveil” the images underlying the coverings. The images associated with the unveiled scratch card boxes indicate whether or not the player has “won.” If a player has won, a value displayed within a prize box may indicate the player's winnings.

FIG. 2 illustrates an example of a representation of a veiled scratch card 202 displayed in conjunction with a scratch card game window 200, in accordance with an example embodiment. Scratch card game window 200 may include, for example, a scratch card display area 204, within which a scratch card may be represented, and one or more action initiation elements 206, which may be manipulated or selected by a player. For example, in an embodiment, an action initiation element may include a selectable “BUY CARD” element 206.

Scratch card 202 may include, for example, multiple game elements. In an embodiment, the game elements may include one or more “play” scratch boxes 210 and one or more “prize” scratch boxes 212. In an embodiment, when a scratch card 202 is initially presented, images or symbols within the boxes 210, 212 may appear to be obscured or veiled by coverings 214. In the illustrated example embodiment, scratch card 202 includes nine play scratch boxes 210 and one prize scratch box 212. In other embodiments, more or fewer than nine scratch boxes 210 and/or more than one prize box 212 may be included within a scratch card. In addition, in other embodiments, some or all of scratch boxes 210 and prize box 212 may be unveiled (e.g., images within the boxes may be visible) when initially presented to a player.

In an embodiment, scratch card game window 200 may include various game state indicators. For example, game state indicators may include a current balance indicator 220, a payout indicator 222, a card price indicator 224, and a card number indicator 226.

Assume, for example, that the game rules for the scratch card specify that, if the player obtains three identical symbols within scratch boxes 210, the player will win the prize specified in prize box 212. When the player selects (e.g., clicks on) the “BUY CARD” element 206, the client device may simulate scratching or removing the scratch box and prize box coverings 214, and unveiling the scratch box images and prize value that lie underneath.

FIG. 3 illustrates an example of a representation of an unveiled scratch card 302 displayed in conjunction with a scratch card game window 300, in accordance with an example embodiment. In an embodiment, when a scratch card 302 is played, images or symbols within the play scratch card boxes 310 and the prize scratch card box 312 may be visible. In the illustrated example embodiment, three matching symbols (e.g., mushrooms) appear within three of the play scratch card boxes 310. Accordingly, the player wins a prize value represented within prize scratch card box 312. In an embodiment, whether a player wins or loses, the player's balance (e.g., as displayed in current balance indicator 320) may be adjusted to reflect the player's winnings or losses. Further, in an embodiment, a player may be given an opportunity to request another scratch card games container by selecting a “NEW CARD” action initiation element 318.

A scratch card (or any other type of games container) may include one or more types of games. For example, a single scratch card games container may include a first game, which pays a first prize if the player matches three identical symbols within nine scratch boxes, and a second game, which pays a second prize if the player uncovers a particular symbol within a bonus scratch box. The player may win one game, both games, or neither game. Accordingly, the player may win one prize, two prizes, or no prizes. For purposes of simplicity, the description herein refers to defining and creating a pre-generated games container (e.g., a scratch card), which includes only one type of game. It is to be understood that a pre-generated games container may include multiple types of games, as well, in various alternative embodiments.

The remaining Figures are used to illustrate processes and apparatus for defining game types and specifying pool-related parameters, producing a pool of pre-generated games containers, and enabling game players to play the game associated with the pool, according to various embodiments. Some of the figures depict flowcharts of methods performed by computing devices. Although the flowcharts are shown as procedures performed in a sequential manner, the various method embodiments could be performed using object-oriented or object-based techniques. Further, the sequence of procedures may be varied, in certain instances, while still achieving substantially similar results. Again, development and implementation of a scratch card game will be described for the purposes of example only, and it is to be understood that the scope of the inventive subject matter extends to various other pre-generated games, as well.

FIG. 4 illustrates a depiction of a game development application 400, in accordance with an example embodiment. In an embodiment, game development application 400 includes a game type definition module 402 adapted to provide a user interface to receive game type definition information, a games container type definition module 403 adapted to provide a user interface to receive games container type definition information, a pool-related parameter specification module 404 adapted to provide a user interface to receive pool-related parameter information, and a pool generation module 406 adapted to generate a pool of pre-generated games containers based on the game type definition information and the pool-related parameter information.

Although the function performed by each of modules 402, 403, 404, 406 may be performed by a single software application, any one or more of the functions may alternatively be performed by distinct software applications. Further, the functions performed by each of modules 402, 403, 404, 406 may be performed one after another in close temporal proximity, or one or more of the functions may be performed after a substantial period of time has elapsed after performance of a previous function. In addition, the functions may be performed on a single computing device or on multiple computing devices.

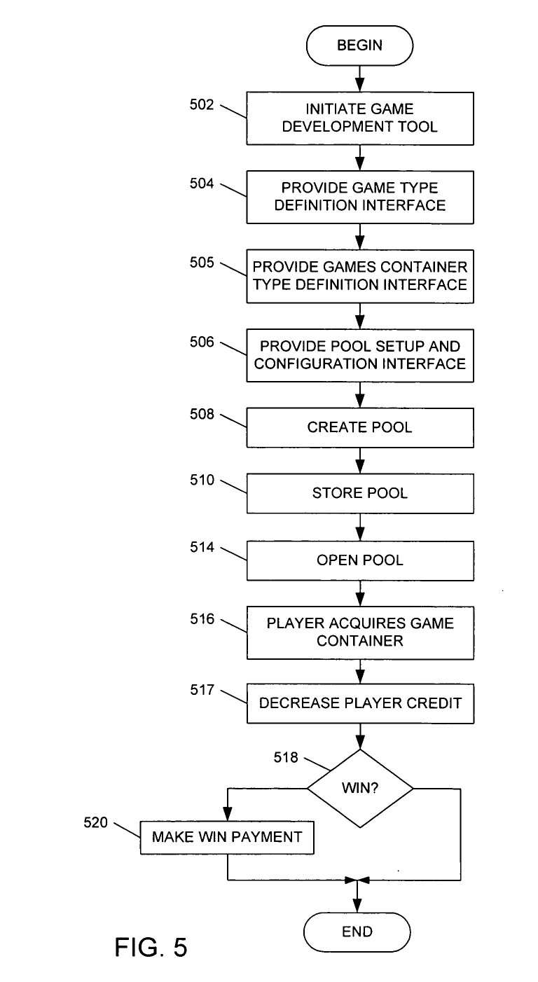

FIG. 5 illustrates a flowchart of a method for creating and playing a pre-generated game, in accordance with an example embodiment. The method begins, in block 502, by initiating a game development application. For example, a game development application may include one or more software modules (e.g., modules 402, 404, 406, FIG. 4, which are executable on one or more development computers (e.g., computer 104, FIG. 1).

In block 504, the game development application (e.g., module 402, FIG. 4) provides the operator with a game type definition interface (e.g., a graphical user interface) and receives game type definition information through the interface. In an embodiment the game type definition interface enables an operator to specify various game-related information. For example, game-related information that an operator may specify may include a “game type,” which may include game logic and game rules.

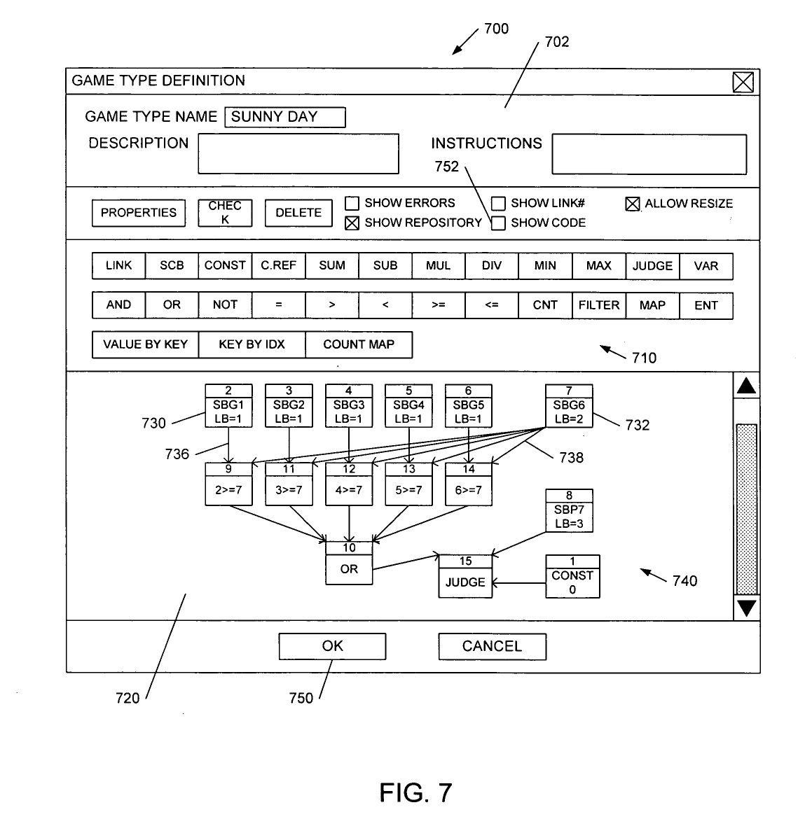

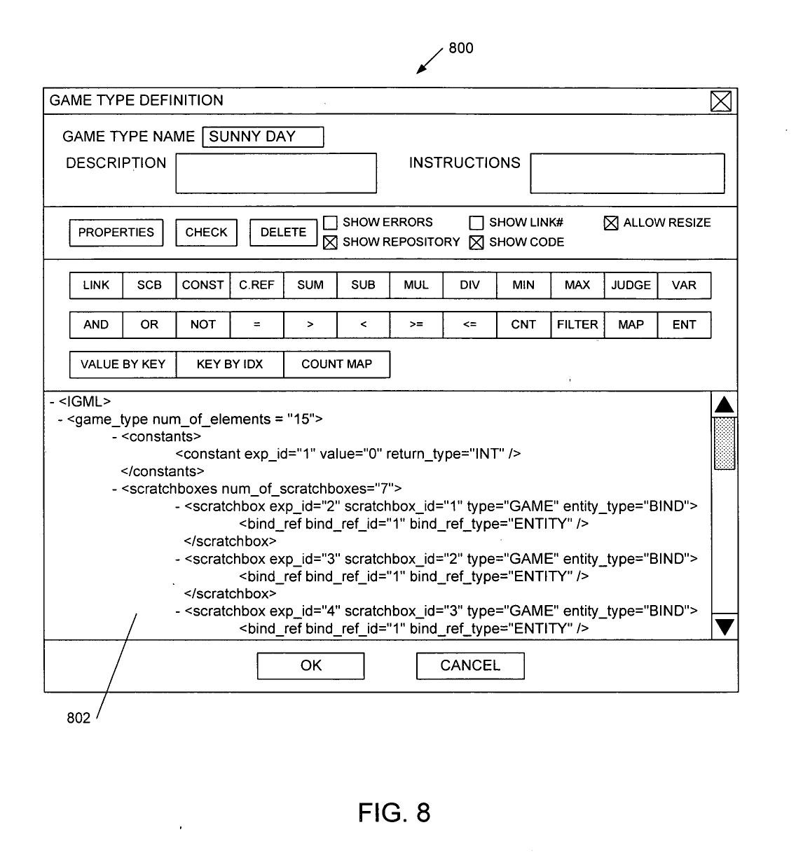

In an embodiment, the game type definition interface may include a “game type definition window,” having various elements that the operator may manipulate to define a game type. In an embodiment, an operator may define a game by arranging and quantifying graphical elements within the window, and specifying interconnections between the elements. Specification of a game type through interaction with a game type definition window will be described in more detail later, in conjunction with FIGS. 7 and 8.

In block 505, the game development application (e.g., module 403, FIG. 4) provides the operator with a games container type definition interface (e.g., a graphical user interface) and receives games container type definition information through the interface. In an embodiment the games container type definition interface enables an operator to specify which of one or more game types a games container will include. For example, an operator may specify that a particular type of games container may include two distinct scratch card types of games.

In block 506, the game development application (e.g., module 404, FIG. 4) provides the operator with a pool setup and configuration interface (e.g., a graphical user interface) and receives pool-related information through the interface. In an embodiment the pool setup and configuration interface enables the operator to specify various pool-related parameters. As indicated previously, a “pool” includes a collection of games containers (e.g., scratch cards) which have pre-generated results. Various pool-related parameters that an operator may specify may include, for example, general pool properties parameters and spread determining parameters.

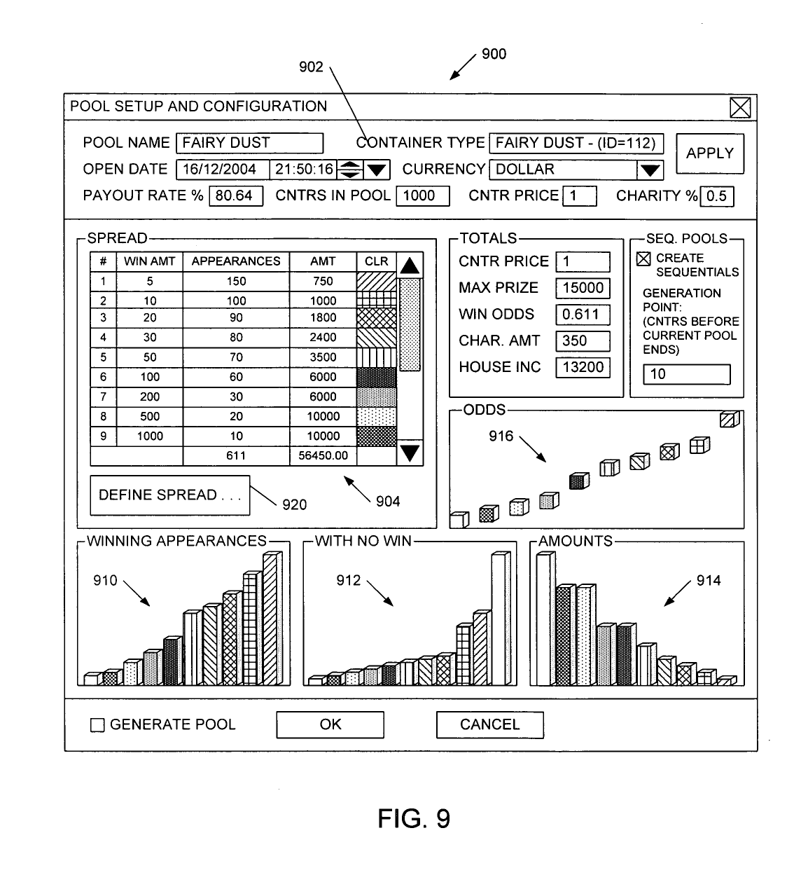

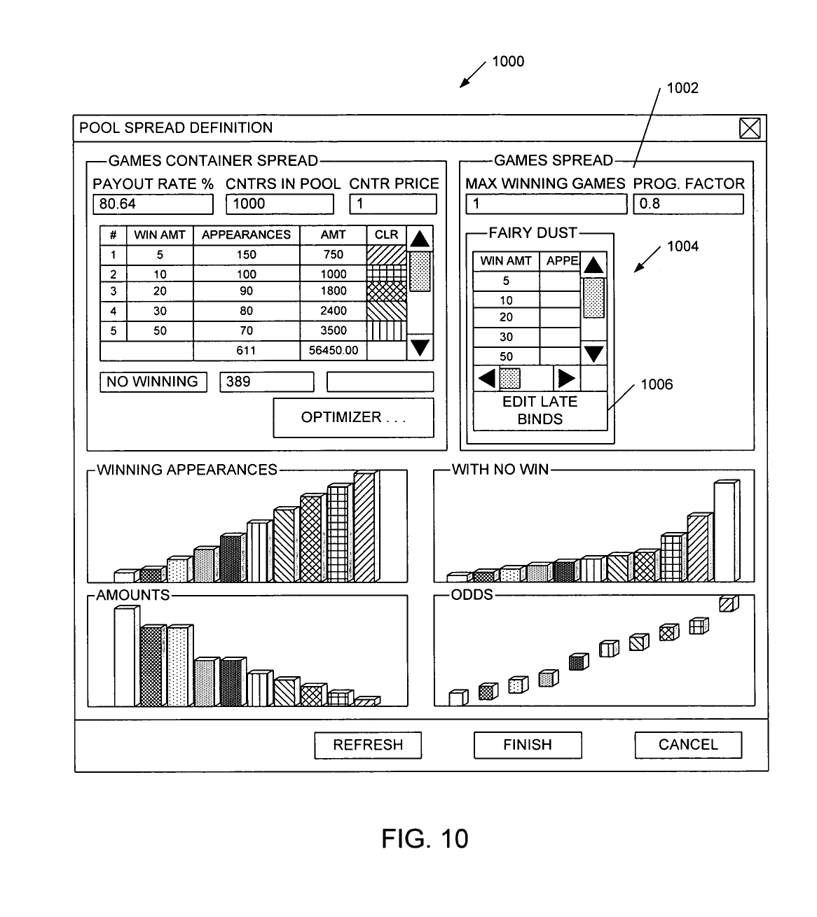

In an embodiment, the pool setup and configuration interface may include a “pool setup and configuration window,” having various elements that the operator may manipulate to specify pool-related parameters. Specification of pool-related parameters through interaction with a pool setup and configuration window will be described in more detail later, in conjunction with FIGS. 9 and 10.

Once the game-related and pool-related parameters have been defined and specified to the satisfaction of the operator, the operator may cause the system to create a pool. In block 508, in response to an operator input (e.g., the operator selecting a “Generate Pool” element of the user interface), the game development application (e.g., module 406, FIG. 4) may create a pool. In an embodiment, pool creation includes generating multiple pre-defined games containers in conformance with the game-related and pool-related parameters. The system also may perform one or more pool validity checks during creation of the games containers or thereafter, in an embodiment.

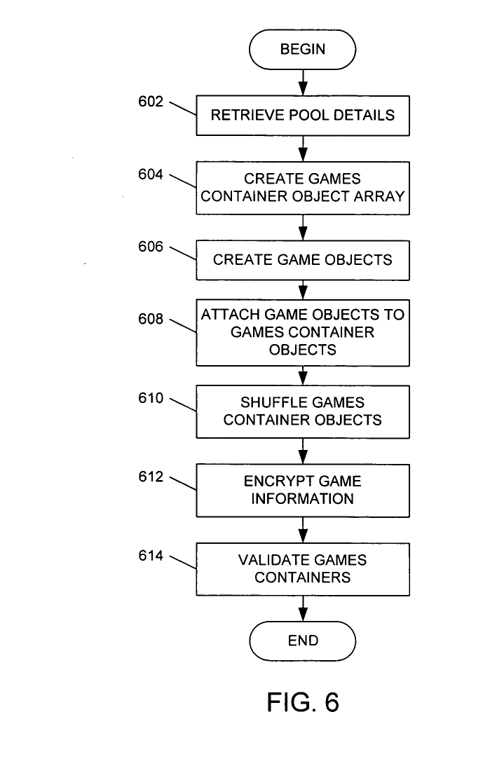

FIG. 6 illustrates a flowchart of a method for creating a pool, in accordance with an example embodiment. The method begins, in block 602, by retrieving pool details. For example, information such as the game types associated with a games container, games container spread information, game type spread information, code relating to each game type, and late binding data relating to each game type may be retrieved.

In block 604, an array of games container objects is created. In an embodiment, information describing each games container object may be stored in a games container object array designated to store information corresponding to each games container. For example, an array entry corresponding to a games container object that includes multiple game types may include game objects for each of the multiple game types. The array may include approximately a number of entries that corresponds to the number of games containers in the pool. In an embodiment, each games container object includes a games container payout according to the designated games container payout spread information.

In block 606, the game development application creates game objects for each game type included in a games container. In an embodiment, each game object includes a set of values and prizes for a games container. In an embodiment, using the game type definitions (e.g., code 802, FIG. 8), the game development application generates game values (e.g., scratch box values) and prizes for as many games containers as are required to complete the games containers in the pool. In addition, in an embodiment, the game development application may validate the generated values and evaluate the game payout for each games container. When the game development application generates values that correspond to an invalid payout or a payout for which a maximum number of games containers has already been generated, then the game development application may discard the values. In an embodiment, each game object includes a game payout according to the designated game type payout spread information.

In block 608, game objects are attached to games container objects. In an embodiment, the game development application may sequentially step through the games container objects in the games container object array, and attach one or more game objects to each games container object. In an embodiment, the game development application pulls game objects according to the game objects payouts, and attaches them to a games container object to achieve the games container object payout.

In an embodiment, once game objects have been attached to the games container objects to create a pool of valid games containers, the game development application may “shuffle” the entries within the games container object array, in block 610. In an embodiment, the game development application may shuffle the array entries one or more times using a shuffling algorithm (e.g., an algorithm that uses O(n) complexity).

In block 612, the game development application may then encrypt game information that represents the symbols and prizes generated for each game object and/or games container object. In an embodiment, the game development application may use a standard algorithm (e.g., 3DES) to perform the encryption.

In block 614, the game development application may then validate each games container. In an embodiment, validation may include ensuring that that the games containers are successfully encrypted. Validation may also or alternatively include the game development application verifying that the numbers of games containers for each payout corresponds to the specified spreads. The pool creation method may then end.

Referring back to FIG. 5, once a pool of games containers has been generated, which substantially or completely complies with the game-related and pool-related parameters, the pool may be stored, in block 510. The pool may be stored, for example, on one or more database computers or servers (e.g., database computer 106, FIG. 1). Accordingly, the pool may be accessible to one or more servers (e.g., server 108, FIG. 1). In an alternative embodiment, all or portions of the pool may be stored on an application server. Once a pool has been stored, a pool status indicator may be updated to indicate that the pool is “READY.”

In block 514, the pool may be opened or activated. A pool may be considered “opened” when some or all of the pool's games containers are available for purchase and/or play by a player (e.g., player 118, FIG. 1). In various embodiments, a pool may be “sequential” or “non-sequential.” A sequential pool may include a pool that is automatically opened when a “parent” pool's games containers are sold out. In an embodiment, pool opening for a non-sequential pool occurs as an automatic process when a pool opening date and time, as specified by the game operator, has been reached. In an embodiment, the system makes a determination whether the specified pool opening date has elapsed. If so, then the system opens the pool. In another embodiment, pool opening may be a manual process, which is initiated by a game administrator. Once a pool has been opened, the pool status indicator may be updated to indicate that the pool is “OPEN.”

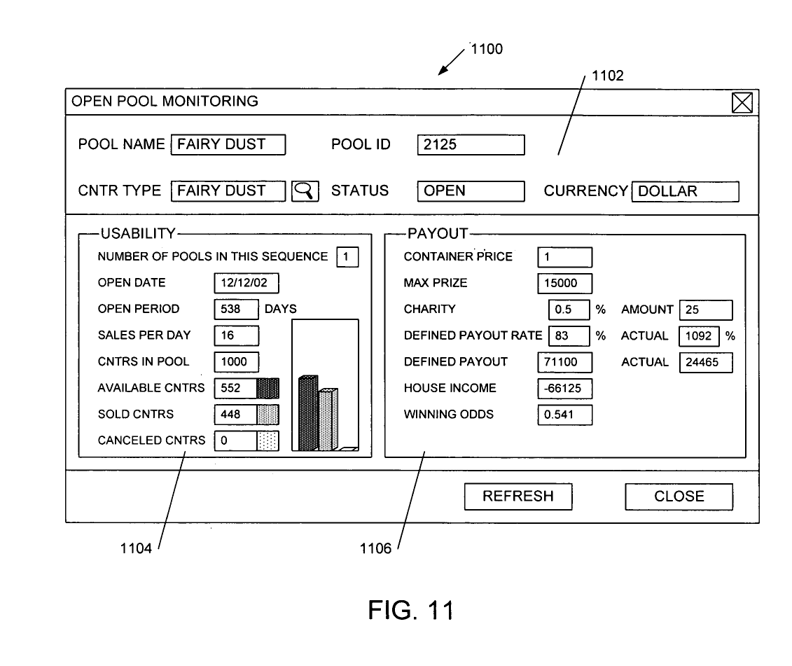

Once opened, performance of a pool (e.g., payout and usability) may be monitored by a game administrator, in an embodiment, by accessing a pool monitoring window. An example of a pool monitoring window will be described in more detail later in conjunction with FIG. 11.

In block 516, a player may acquire a games container for play. In an embodiment, a player may interact with a client device (e.g., client device 110, FIG. 1) to cause the client device to request a representation of a games container (e.g., scratch card 200, FIG. 2) from a pre-generated game application executing at a server. In some embodiments, a player may be required to purchase a games container for a sum of money (or any other exchange of value such as credits, coupons, accumulated points, or the like) prior to play. In such an embodiment, the system may require the player to establish credit with the system. Credit may be established, for example, by prompting the player for credit card information, and then making an authorized charge to the card. Alternatively, some types of client devices (e.g., video gaming terminals) may enable a player to insert coins or bills, or swipe a credit card. In other embodiments, a player may not be required to purchase games containers, and instead may be allowed to access games containers gratuitously (e.g., when playing only for entertainment, and not for actual winnings).

When a client device sends a request for a games container to a server, the server may, in response, select a games container from the pool, decode and validate the games container, and send a representation of the games container (e.g., a veiled scratch card, such as card 200, FIG. 2) to the client device. A player may then indicate that the player would like to execute the games container (e.g., play the game). For example, a player may select a “BUY CARD” element (e.g., element 206, FIG. 2). In an embodiment, when a player indicates that the player would like to purchase a games container, the client device sends a message to the server, and the server, in turn, may send one or more additional representations of the games container (e.g., partially or completely unveiled scratch cards, such as card 300, FIG. 3) to the client device. Once a player has indicated that he or she would like to purchase a games container, the server may decrease the amount of credit available to the player, in block 517, in order to pay for the games container.

Because the games containers are pre-generated, a server may know the outcome of a games container even before the games container is provided to the client device. In an embodiment, the server determines whether a games container pertains to a winning instance or a losing instance, in block 518. When a games container pertains to a winning instance, the server may make a win payment of a net value of the win, in block 520. For example, the server may increase the value of the credits that the player has with the system.

A player may or may not indicate that he or she would like to purchase another games container. If the player does purchase one or more additional games containers, then the processes of blocks 516, 517, 518, and 520 (if the container wins) are repeated, and the player's balance is adjusted upward or downward during each play. After one or more iterations of playing a particular game, a player may request payout, and the method ends. For purposes of ease of description, multiple iterations of game play are not depicted in FIG. 5.

Various aspects and embodiments of the above described processes will now be described from the perspectives of a game operator and game administrator. In particular, embodiments of graphical user interfaces that facilitate game type specification, pool-related parameter specification, pool creation, pool opening, and pool performance monitoring will be described below, in conjunction with FIGS. 7-11.

As described previously, if a game operator wishes to create a pre-generated game, the operator may initiate a game development application (e.g., block 502, FIG. 5) on a development computer (e.g., computer 104, FIG. 1), in an embodiment. The game development application may prompt the operator for game-related and pool-related information using a series of one or more graphical user interfaces or windows, in an embodiment. These windows may also or alternatively convey information to the operator. FIGS. 7-11 illustrate five example windows for prompting an operator for information and for conveying game-related and pool-related information. It would be apparent to one of skill in the art that more or fewer windows may be used to prompt the operator for or convey this information. Further, the various portions of information may appear in different combinations in different windows, and more, fewer or different information prompts and display areas may be provided in the various windows. Accordingly, it is to be understood that the example windows in FIGS. 7-11 are for the purposes of illustration, and not of limitation.

In an embodiment, upon initiation of the game development application, the game operator may wish to specify game type information. In an embodiment, to facilitate entry of game type information, the game development application provides a game type definition interface (e.g., block 504, FIG. 5). A game type definition interface may take the form of a game type definition window, in an embodiment.

FIG. 7 illustrates an example of a game type definition window 700, in accordance with an example embodiment. Window 700 may include first elements 702, which enable the operator to specify a game type name, description, and instructions. In alternative embodiments, more, fewer or different elements may be included within a game type definition window to enable an operator to specify game-related information.

In addition, in an embodiment, window 700 may include a repository 710 of building blocks (e.g., abstract elements and operations), which an operator may select and interconnect to generate a flow diagram. For example, in an embodiment, the operator may move (e.g., drag and drop) selected building blocks into a graphical diagram area 720. When a building block is moved into graphical diagram area 720, a graphical element (e.g., element 730) may appear in proximity to a drop location.

In an embodiment, each graphical element includes an expression identifier (ID) and an expression. For example, element 730 includes an expression ID of “2” and an expression “SBG1 LB=1.” Conversely, element 732 includes an expression IUD of “7” and an expression “SBG6 LB=2.” Various expressions will be explained in more detail later. An expression ID may be sequentially assigned to graphical elements as they are moved into graphical diagram area 720. Expressions may indicate an operation or value associated with an element.

The graphical elements may be interconnected together, such as by links 736, 738. Links 736, 738 may represent the correlation and reciprocation between graphical elements. Accordingly, in an embodiment, game rules may be defined by providing a set of graphical elements and establishing links between the graphical elements. In an embodiment, the system may provide error feedback, for example, when the operator attempts to interconnect graphical elements that are not compatibly linkable.

By introducing and interconnecting multiple graphical elements within graphical diagram area 720, an operator may produce a flow diagram (e.g., flow diagram 740). In an embodiment, flow diagram 740 represents software in a graphical way. For example, each graphical element may correspond to a software object (e.g., one or more lines of code) consistent with a proprietary or non-proprietary language. In an embodiment, each graphical element may correspond to a code fragment having a proprietary Instant Game Markup Language (IGML) format, which will be described in more detail later. Accordingly, each building block within repository 710 may correspond to one or more IGML-described operations or entities.

Within game type definition window 700, the game logic and game rules are represented by displaying interconnected graphical elements. In other embodiments, the game logic and game rules may additionally or alternatively be represented by displaying lines of code. The game development application enables an operator to indicate whether he or she would like to view the game logic and game rules in a graphical or lines of code format, in an embodiment. Further, in an embodiment, an operator may indicate that he or she would like to specify the game logic and game rules by writing lines of code, rather than by manipulating graphical elements.

When the game development application receives a flow diagram that defines game logic and game rules, the game development application may, at any of several times, convert the graphical representation into lines of code. In an embodiment, the game development application generates an IGML text file based on the flow diagram, wherein the IGML text file includes operations and entities specifying a structure of the pre-generated game type.

In an embodiment, conversion may be performed when the operator selects a window element, such as “OK” element 750, for example. In another embodiment, conversion may be performed when the operator selects an element, such as “Show Code” element 752. Selection of “Show Code” element 752 may also or alternatively cause the application to display some or all of the lines of code corresponding to the graphical representation 740.

FIG. 8 illustrates an example of a game type definition window 800 with an example game represented using lines of code 802, in accordance with an example embodiment. In an embodiment, software for a game type definition may have a format that is consistent with a proprietary language (e.g., IGML, as mentioned previously). In another embodiment, software for game type definition may have a format that is consistent with another proprietary or non-proprietary language (e.g., C++).

In an embodiment, a game operator may also wish to specify pool-related parameter information. In an embodiment, to facilitate entry of pool-related parameter information, the game development application provides a pool setup and configuration interface (e.g., block 506, FIG. 5). A pool setup and configuration interface may take the form of a pool setup and configuration window, in an embodiment.

FIG. 9 illustrates an example of a pool setup and configuration window 900, in accordance with an example embodiment. Window 900 may include elements enabling an operator to specify general pool parameters and spread determining parameters, in an embodiment.

Window 900 may include general pool parameter elements 902, which enable the operator to specify general pool parameters, such as a pool name, games container type, pool opening date, currency, payout rate, number of games containers (“CNTRS”) in the pool, games container price, and charity percentage or amount, in an embodiment. Pool setup and configuration window 900 also may include spread determining parameter elements 904, in an embodiment, which enable the operator to specify spread-related parameters, such as various win amounts (“WIN AMT”) and appearances per win amount (“APPEARANCES”). In alternative embodiments, more, fewer or different elements may be included within a pool setup and configuration window to enable an operator to specify pool-related information.

In an embodiment, the system may produce additional information based on the operator-specified parameters. For example, the system may calculate and display information such as a total amount of projected winnings per win amount (e.g., “AMT”=“WIN AMT”×“APPEARANCES”), winning odds (“WIN ODDS”), a total charity amount (“CHAR. AMT”), and anticipated house income (“HOUSE INC”), among other things. In an embodiment, the system additionally may calculate and display one or more charts or graphical representations 910, 912, 914, 916, which reflect anticipated results of the pool-related specifications. Components (e.g., bars) of the graphical representations 910, 912, 914, 916 may show correlations with various win amounts (or other specified parameters) using corresponding colors or patterns, in an embodiment.

As mentioned previously, some games containers may include multiple game types (e.g., two distinct scratch card games carrying two distinct prizes on a single card). In an embodiment, an operator may be able to configure prize spreads for multiple game types included in a games container. In an embodiment, to facilitate specification of prize spreads for multiple game types of a particular games container, the game development application may provide a pool spread interface. A pool spread interface may take the form of a pool spread definition window, in an embodiment. A pool spread window may be accessed, for example, when an operator selects a “DEFIE SPREAD . . . ” element 920, for example.

FIG. 10 illustrates an example of a pool spread definition window 1000, in accordance with an example embodiment. Window 1000 may include games container spread elements 1002 and game type spread elements 1004. Games container spread elements 1002 enable the operator to specify spread-related parameters for the games containers (e.g., the scratch cards), and game type spread elements 1004 enable the operator to specify spread-related parameters for each game type represented within each games container. In alternative embodiments, more, fewer or different elements may be included within a pool spread definition window to enable an operator to specify games container and/or game type spread information.

In an embodiment, the system also may provide the operator the option to combine “late bind” values (described later) correlating to the game rules and logic defined for each game type included in the pool's games container type. For example, the operator may initiate combining late bind values by selecting an “EDIT LATE BINDS” element 1006 associated with a particular game type.

Once a pool has been opened (e.g., in block 514, FIG. 5), a game administrator may want to monitor the status of the pool's performance. Based on the pool's performance, the game administrator may want to take certain actions. In an embodiment, the system may enable a game administrator to freeze the pool (e.g., disable its use by changing the pool status indicator to “DISABLED”), run a validity check process (e.g., to ensure that the pool has not been tampered with), view the pool's definitions and configurations, and view the history of pool updates.

In an embodiment, to facilitate open pool monitoring, the system may provide an open pool monitoring interface. An open pool monitoring interface may take the form of an open pool monitoring window, in an embodiment. An open pool monitoring window may be accessed from an administrator's computer, for example, which may communicate with a server that supports execution of a pre-generated game application.

FIG. 11 illustrates an example of an open pool monitoring window 1100, in accordance with an example embodiment. Window 1100 includes general parameter elements 1102, which enable an administrator to view general pool information. For example, general parameter elements 1102 may include a pool name, pool ID number, games container type, pool status (e.g., open, disabled, not yet open, closed), and currency.

Open pool monitoring window 100 may also include pool usability elements 1104, which enable an administrator to view the pool use up to a certain date (e.g., to present). For example, pool usability elements 1104 may include an open date, open period, number of games container sales per day, number of games containers in the pool, number of available games containers (e.g., games containers not yet sold or canceled), number of sold games containers, and number of canceled games containers.

Open pool monitoring window 1100 may also include pool payout elements 1106, which enable an administrator to view the pool payout information up to a certain date (e.g., to present). For example, pool payout elements 1106 may include games container price, maximum prize, charity percentage, accumulated charity winnings, defined payout rate, actual payout rate, defined payout, actual payout, house income, and actual winning odds. In alternative embodiments, more, fewer or different elements may be included within a pool monitoring window to enable an administrator to view general pool parameters, pool usability, and pool payout information.

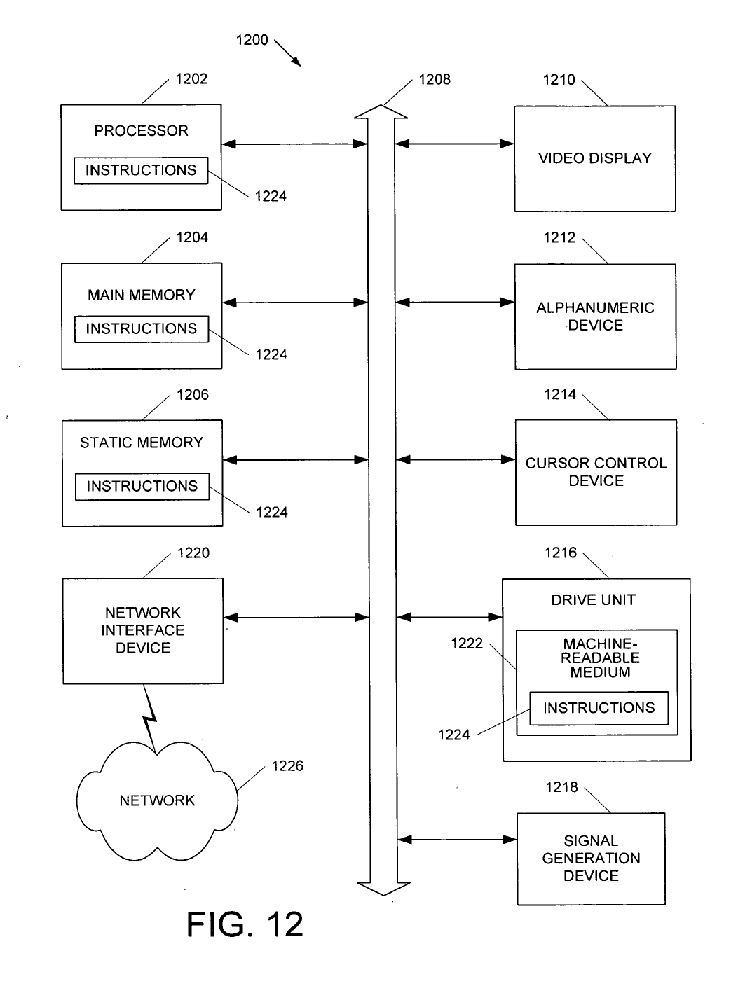

FIG. 12 shows a diagrammatic representation of machine in the example form of a computer system 1200, within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer, a laptop computer, a personal digital assistant (PDA), a two-way pager, a cellular telephone, a television set and set-top box, an interactive television (ITV) system, a gaming system, a hotel service system, a consumer electronics device, a web appliance or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1200 includes a processor 1202 (e.g., a central processing unit (CPU), a graphics processing unit (GPU) or both), a main memory 1204, and a static memory 1206, which communicate with each other via a bus 1208. The computer system 1200 may further include a video display unit 1210 (e.g., a liquid crystal display (LCD) or a cathode ray tube (CRT)). The computer system 1200 also may include an alphanumeric input device 1212 (e.g., a keyboard), a user interface (UI) navigation device 1214 (e.g., a mouse), a disk drive unit 1216, a signal generation device 1218 (e.g., a speaker), and a network interface device 1220.

The disk drive unit 1216 includes a machine-readable medium 1222 on which is stored one or more sets of instructions and data structures (e.g., software 1224) embodying or utilized by any one or more of the methodologies or functions described herein. The software 1224 may also reside, completely or at least partially, within the main memory 1204 and/or within the processor 1202 during execution thereof by the computer system 1200, the main memory 1204 and the processor 1202 also constituting machine-readable media. The software 1224 may further be transmitted or received over a network 1226 via the network interface device 1220 utilizing any one of a number of well-known transfer protocols (e.g., HTTP).

While the machine-readable medium 1222 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

The various procedures described herein can be implemented in hardware, firmware or software. A software implementation could use microcode, assembly language code, or a higher-level language code to define a set of program instructions. The program instructions may be stored on one or more volatile or non-volatile computer readable media which, during execution, may perform various embodiments of the methods described herein. These computer readable media may reside at a server, a client device, or both, and may include hard disks, removable magnetic disks, removable optical disks, magnetic cassettes, flash memory cards, digital video disks, Bernoulli cartridges, random access memories (RAMs), read only memories (ROMs), and the like.

Instant Game Markup Language:

As described previously, a game development application may enable a game operator to create a game type definition in an Instant Game Markup Language (IGML), in an embodiment. The inventive subject matter of this application includes IGML. A more detailed description of various aspects and embodiments of IGML will now be given.

In an embodiment, IGML has a syntax that is defined by Extensible Markup Language (XML) rules. IGML includes two aspects: 1) the markup language itself; and 2) a flow diagram descriptive methodology (e.g., a methodology for creating graphical diagrams that simplifies the process of building a game type's descriptive code. In various embodiments, IGML may perform some or all of the following actions: 1) validate a given pre-generated game; 2) judge a given pre-generated game; and 3) generate a given pre-generated game's pool.

In an embodiment, a games container may include one or more pre-generated games. The games are bounded together to become the games container itself. In order to judge or validate a games container, three components may be considered: 1) game type descriptions (e.g., descriptions of the games that are bounded with the games container); 2) a description file for game types in the games container (e.g., XML-based description files); 3) scratch box symbols (e.g., the symbol numbers that appear in each of the games' scratch boxes; and 4) late binding parameters (e.g., an XML-based file that includes additional parameters that do not appear in the game type descriptions, but which may be bound to them later). In an embodiment, there is one late binding parameter for each of the game types in the games container. In other words, there are as many late binding parameters as there are game types in the games container, in an embodiment.

At least three elements may be used to generate a pool for a pre-generated game. These elements include: 1) descriptions of one or more game types that may appear on a games container; 2) late binding parameters; and 3) pool spread information (e.g., the number of games containers in the pool and the number of times each prize may appear).

IGML includes two elements: 1) a game type element; and 2) a late bind element. The game type element includes the relevant data regarding a single game type. A games container may contain one or multiple games, where each game can be of the same or different types. The late bind element holds relevant data that binds with the game type element. A game type element may be missing some data that was not accessible when the game type definition was generated (e.g., pool-related information). Late bind elements may be bound with game type elements in order to include the missing information.

Game types may be represented using IGML flow diagrams. In the context of an IGML flow diagram or IGML code, a game type may include several aspects. These include expressions, scratch boxes, entities, and late bind elements.

Expressions may include integer expressions, Boolean expressions, and map expressions. Integer expressions may return integer values, and may include, for example but not by way of limitation, sum, subtract, multiply, divide, min, max, value by key (returns a value that is mapped to the key in a given map), key by index (returns the key that is located in the index place in a given map), count map elements (returns the number of different keys in a given map), judge (returns “A” if a test is true and “B” if a test is false), and var (returns a next element in a list). Boolean expressions may return Boolean values, and may include, for example but not by way of limitation, and, or, not equals, bigger than, smaller than, bigger equals (returns true if the left parameter is bigger than or equal to the right parameter), and smaller equals (returns true if the left parameter is smaller than or equal to the right parameter). Map expressions may return a map value (e.g., a list of key-value pairs) and may include, for example but not by way of limitation, count (returns a map that represents the amount of times every value appears in the parameter list) and filter (returns a map that contains all the pairs in the input map that passed a test presented by a Boolean expression “test”).

Scratch boxes represent actual scratch boxes that appear on a games container. A “prize” scratch box contains a representation of the prize that a player receives if the games container is a winning games container. A “game” scratch box contains a symbol that, along with the other game scratch boxes in the game, determines if the games container is a winner or a loser. In some cases, where a games container has a winning table, the game scratch boxes may determine the prize as well, because the prize amount may not be determined by a prize scratch box, but rather by a winning sequence of symbols.

Entities are related to scratch boxes. In particular, entities are a set of weighted limits for a scratch box to obey. For a scratch box value to be valid, the value should meet the scratch box's entity requirements. Entities may be used to expedite the games container generation process. Every possible value within a given limit is given a weight. The probability of a value appearing is related to its weight.

Late bind elements represent parameters that are not known at the time of game type definition. Late bind elements may include, for example, prize scratch box entities, game scratch box entities, and multiplicands for win tables. In an embodiment, each game type within a games container includes a late bind element.

Thus, various embodiments of a method, apparatus, and system have been described for creating games having pre-generated results. Embodiments may be used in conjunction with numerous different systems, including but not limited to wired or wireless computer networks, cellular communication systems, cable systems, satellite communication systems, hotel service systems, interactive television systems, two-way paging systems, and casino-style gaming networks, among others. Further, embodiments may be used in conjunction with numerous different client platforms, including but not limited to wired or wireless computers (portable or stationary), cellular telephones, interactive television terminals, video lottery terminals (VLTs), personal data assistants, pagers, and gaming terminals, among others.

As mentioned previously, examples of pre-generated games that may be implemented using various embodiments include, but are not limited to, scratch card games, keno, bingo, and other games that include pre-generated games containers (e.g., cards). It is to be understood that other types of games also may be implemented using various embodiments. Other types of games, such as blackjack, may not usually be implemented using pre-generated games containers, but instead may generate results as the games are being played (e.g., using random result generation processes). However, some games that may appear to be generating results during play may be implemented by simulating play using pre-generated results. Accordingly, other examples of applicable pre-generated games may include, but are not limited to, blackjack, poker, roulette, craps, slot machines, and other types of games that are implemented by simulating play using pre-generated results.

The foregoing description of specific embodiments reveals the general nature of the inventive subject matter sufficiently that others can, by applying current knowledge, readily modify and/or adapt it for various applications without departing from the generic concept. Therefore such adaptations and modifications are within the meaning and range of equivalents of the disclosed embodiments. The phraseology or terminology employed herein is for the purpose of description and not of limitation. Accordingly, the inventive subject matter embraces all such alternatives, modifications, equivalents and variations as fall within the spirit and broad scope of the appended claims.

1. A method comprising:
providing a user interface to receive a game type definition, which defines a pre-generated game type; and
providing a user interface to receive pool-related parameters, which define a pool of pre-generated games containers for a pre-generated game.

2. The method of claim 1, further comprising:
generating the pool of pre-generated games containers based on the game type definition and the pool-related parameters.

3. The method of claim 1, wherein providing the user interface to receive the game type definition comprises:
providing a graphical user interface that includes a repository of building blocks, which may be selected and interconnected to generate a flow diagram corresponding to the game type definition.

4. The method of claim 3, further comprising:
generating an instant game markup language text file based on the flow diagram, wherein the instant game markup language text file includes operations and entities specifying a structure of the game type definition.

5. A computer readable medium having program instructions stored thereon, which when executed within a computer, perform the method of claim 1.

6. A method comprising:
receiving a game type definition and pool-related parameters for a pre-generated game;
creating a games container object array to store multiple games containers;
creating multiple game objects, based on the game type definition and the pool-related parameters; and
attaching at least some of the multiple game objects to the multiple games containers.

7. The method of claim 6, wherein receiving the game type definition includes receiving a game type definition for a scratch card game type.

8. The method of claim 6, further comprising:
providing a user interface to receive the game type definition; and
providing a user interface to receive the pool-related parameters.

9. A computer readable medium having program instructions stored thereon, which when executed within a computer, perform the method of claim 6.

10. A method comprising:
receiving a flow diagram defining a pre-generated game type;
generating an instant game markup language text file based on the flow diagram, the instant game markup language text file including operations and entities specifying a structure of the pre-generated game type; and
generating a pool of games containers for the pre-generated game type based on the instant game markup language text file.

11. The method of claim 10, further comprising:
providing a graphical user interface that allows an operator to generate the flow diagram, wherein the graphical user interface includes a repository of abstract elements and operations selectable and interconnectable by the operator to generate the flow diagram.

12. The method of claim 10, wherein the syntax of the instant game markup language is defined by Extensible Markup Language (XML) rules.

13. A computer readable medium having program instructions stored thereon, which when executed within a computer, perform the method of claim 10.

14. A method comprising:
providing a user interface to receive a game type definition for a pre-generated game;
receiving the game type definition in the form of a flow diagram defining the game type;
generating an instant game markup language text file based on the flow diagram, the instant game markup language text file including operations and entities specifying a structure of the pre-generated game type;
providing a user interface to receive pool-related parameters, which define a pool of games containers for the pre-generated game;
receiving the pool-related parameters;
creating a games container object array to store the pool of games containers;
creating multiple game objects, based on the game type definition and the pool-related parameters; and
attaching at least some of the multiple game objects to the games containers to generate the pool of games containers.

15. A software application comprising:
a first module adapted to provide a user interface to receive a game type definition; and
a second module adapted to provide a user interface to receive pool-related parameters.

16. The software application of claim 15, further comprising:
a third module adapted to generate a pool of pre-generated games containers based on the game type definition and the pool-related parameters.

17. The software application of claim 15, wherein the first module is to cause a game type definition window to be displayed by a computer, wherein the game type definition window includes a repository of building blocks, selectable and interconnectable to generate a flow diagram corresponding to the game type definition.

18. The software application of claim 17, wherein the first module is to further adapted to generate an instant game markup language text file based on the flow diagram, wherein the instant game markup language text file includes operations and entities specifying a structure of the game type definition.

19. The software application of claim 15, wherein the second module is to cause a pool setup and configuration window to be displayed on a display device, wherein the pool setup and configuration window includes elements to allow the input of spread-related information for the pool.

20. A computer comprising:
a first module adapted to provide a user interface to receive a game type definition; and
a second module adapted to provide a user interface to receive pool-related parameters.

21. The computer of claim 20, further comprising:
a third module adapted to generate a pool of pre-generated games containers based on the game type definition and the pool-related parameters.

22. An apparatus comprising:
means for providing a user interface to receive a game type definition;
means for providing a user interface to receive pool-related parameters; and
means for generating a pool of pre-generated games containers based on the game type definition and the pool-related parameters.
